(19) United States
(12) Patent Application Publication
(10) Pub. No.: US 2012/0034543 A1
(43) Pub. Date: Feb. 9, 2012

(54) FUEL CELL SEPARATOR, AND FUEL CELL STACK AND FUEL CELL SYSTEM USING SAME

(76) Inventors: Katsumi Kozu, Hyogo (JP); Takashi Akiyama, Osaka (JP)

(21) Appl. No.: 13/190,080

(22) Filed: Jul. 25, 2011

(30) Foreign Application Priority Data
Aug. 5, 2010 (JP) 2010-175952

(51) Int. Cl. H01M 8/04; H01M 8/24

(52) U.S. Cl. 429/457; 429/514

(57) ABSTRACT

A separator used in a fuel cell stack includes an inlet chamber, a plurality of partition walls, and an outlet chamber. The partition walls are formed in the same length in an equal interval from the inlet chamber to the outlet chamber so as to form a plurality of linear passages. The outlet chamber is formed at an end side of the partition walls. The outlet chamber is provided with a first outlet and a second outlet opening in the facing edges of the separator. A space is provided between the center partition wall and the inner wall surface of the separator in the outlet chamber, and the first outlet and the second outlet communicate with each other via the space.

### BACKGROUND OF THE INVENTION

1. Field of the Invention

The present invention relates to a fuel cell separator, and a fuel cell stack and a fuel cell system using the fuel cell separator. More particularly, the present invention relates to a passage structure at a cathode side of a separator.

2. Background Art

Recently, with the rapid widespread of portable and cordless electronic devices, as driving power sources for such electronic devices, secondary batteries having a small size, light weight and large energy density have been increasingly demanded. Furthermore, technology development has been accelerated in not only secondary batteries used for small consumer goods but also large secondary batteries for electric power storages and electric vehicles, which require durability and safety over a long period. In addition, more attention has been paid to fuel cells that can be continuously used for a long time with fuel supplied rather than secondary batteries that need charging.

A fuel cell system is provided with a fuel cell stack including a cell stack, a fuel supply section for supplying fuel to the cell stack, and an oxidizing agent supply section for supplying gas containing an oxidizing agent. The cell stack is formed by laminating membrane electrode assemblies and separators to each other, and disposing an endplate on each of the both end sides in the laminating direction. Each membrane electrode assembly is composed of an anode electrode, a cathode electrode, and an electrolyte membrane interposed between the anode and cathode electrodes.

Each of a surface of the anode-side end plate and a surface of the separator facing the anode electrode is provided with a serpentine groove in order to supply fuel to the entire surface of the anode electrode. Likewise, each of a surface of the cathode-side end plate facing the cathode electrode and a surface of the separator facing the cathode electrode is provided with a serpentine groove in order to supply gas containing an oxidizing agent to the entire surface of the cathode electrode. In general, both these grooves are formed such that they extend in the direction perpendicular to each other and they are folded back and forth (to right and left) in a meander form.

However, when liquid such as water is generated as a product at a cathode side depending on operation conditions, a passage formed by the serpentine grooves may be closed with this liquid product. Furthermore, in a case of such a passage shape, as an area of the cathode electrode becomes larger and the length of the passage becomes longer, a pressure loss in the passage is increased. Therefore, in order to supply gas containing an oxidizing agent to the downstream side, it is necessary to increase a discharging pressure of a pump as an oxidizing agent supply section. This makes it difficult to miniaturize a fuel cell system and this increases the power consumption of the pump. As a result, energy conversation efficiency of the fuel cell system is reduced.

### SUMMARY OF THE INVENTION

A fuel cell separator according to the present invention includes a first surface configured to face a cathode electrode, and a second surface provided on a rear side of the first surface and configured to face an anode electrode. The separator includes a first edge, a second edge that is adjacent to the first edge, a third edge that faces the first edge and is adjacent to the second edge, and a fourth edge that faces the second edge. The first surface includes an inlet (gas inlet) provided on the first edge side, an inlet chamber linked to the inlet, a first outlet provided on the second edge side, a second outlet provided on the fourth edge side, an outlet chamber linked to the first and second outlets, a plurality of linear partition walls, and a center partition wall. The linear partition walls are provided in parallel to each other in the direction from the first edge to the third edge, and the center partition wall is provided in parallel to the linear partition walls at a center position, in the direction from the first edge to the third edge. The partition walls have the same length. Each two of the partition walls, and the center partition wall and two of the partition walls neighboring the center partition wall form a plurality of linear passages having the same width therebetween, which are linked between the inlet chamber and the outlet chamber along the direction from the first edge to the third edge. A space is provided between the center partition wall and an inner wall surface of the third edge, and the first outlet and the second outlet communicate with each other via the space.

In addition, a fuel cell stack of the present invention includes a cathode-side end plate, a membrane electrode assembly, and an anode-side end plate. The membrane electrode assembly is formed by laminating a cathode electrode that faces the cathode-side end plate, an anode electrode provided on a rear side of the cathode electrode, and an electrolyte membrane interposed between the cathode electrode and the anode electrode to each other. The anode-side end plate faces the anode electrode. The cathode-side end plate has a similar structure to that of the first surface of the separator mentioned above on a cathode-facing surface that faces the cathode electrode.

Furthermore, a fuel cell system of the present invention includes the above-mentioned fuel cell stack, a fuel supply section, and a gas supply section. A fuel passage is provided on a surface of the anode-side end plate, which faces an anode electrode, and a fuel inlet linked to the fuel passage on the edge corresponding to the third edge of cathode-side end plate. The fuel supply section is disposed on a surface side including the third edge of the cathode-side end plate of the fuel cell stack, and supplies a fuel to the fuel inlet of the anode-side end plate. The gas supply section supplies gas containing an oxidizing agent to the gas inlet of the cathode-side end plate.

### BRIEF DESCRIPTION OF DRAWINGS

FIG. 1 is a block diagram showing a configuration of a fuel cell system in accordance with an embodiment of the present invention.

FIGS. 2A and 2B are perspective views of a fuel cell stack in accordance with the embodiment of the present invention.

FIG. 3 is a plan view of a surface, which faces a cathode electrode, of a separator of the fuel cell stack shown in FIGS. 2A and 2B.

FIG. 4 is a plan view of a surface, which faces an anode electrode, of the separator of the fuel cell stack shown in FIGS. 2A and 2B.

FIG. 5 is a conceptual sectional view showing an outline configuration of a principal part of the fuel cell stack shown in FIGS. 2A and 2B.

FIG. 6 is a perspective view for illustrating a connection between the fuel cell stack shown in FIGS. 2A and 2B and a fuel pump shown in FIG. 1.

FIG. 7 is a perspective view for illustrating a connection between the fuel cell stack shown in FIGS. 2A and 2B and an air pump shown in FIG. 1.

FIG. 8 is a front view of the first side surface of the fuel cell stack shown in FIGS. 2A and 2B.

FIG. 9 is a sectional view of an integrated member to be attached onto the first side surface of the fuel cell stack shown in FIGS. 2A and 2B.

### DETAILED DESCRIPTION OF THE INVENTION

Hereinafter, an embodiment of the present invention is described with reference to drawings in which a direct methanol fuel cell (DMFC) is taken as an example. Note here that the present invention is not limited to the contents described below as long as it is based on the basic features described in the present specification.

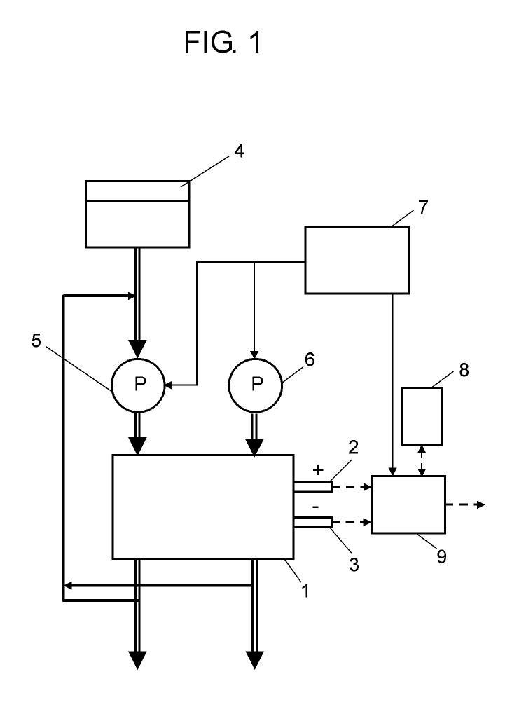

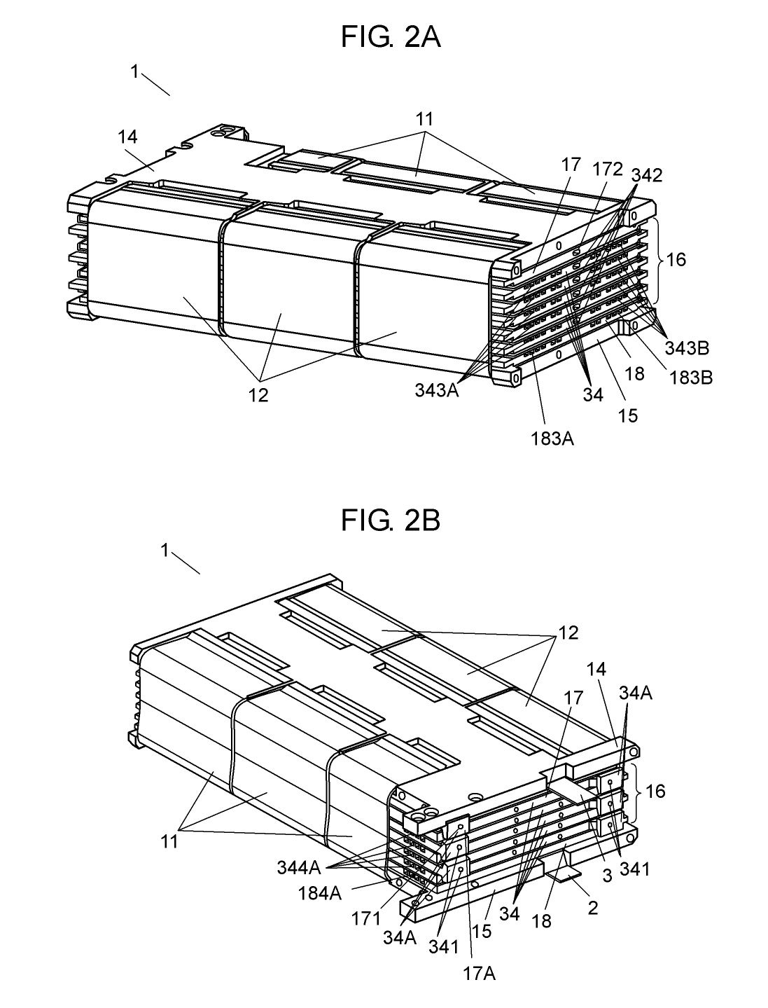

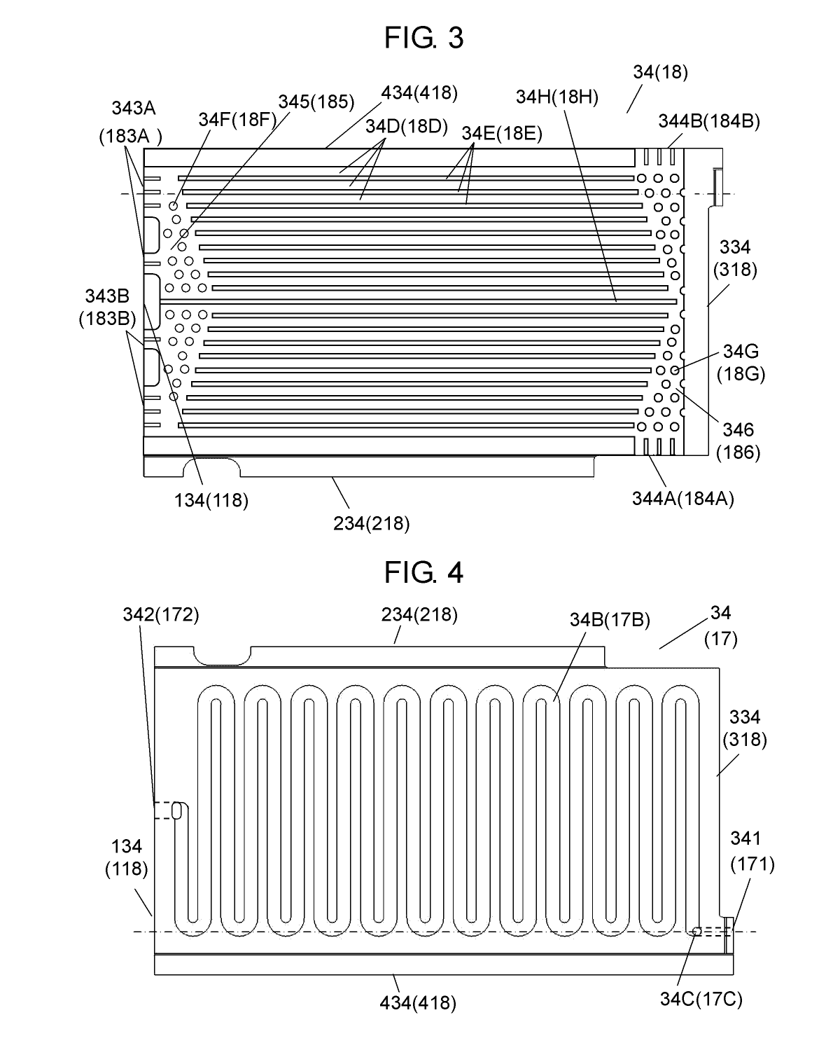

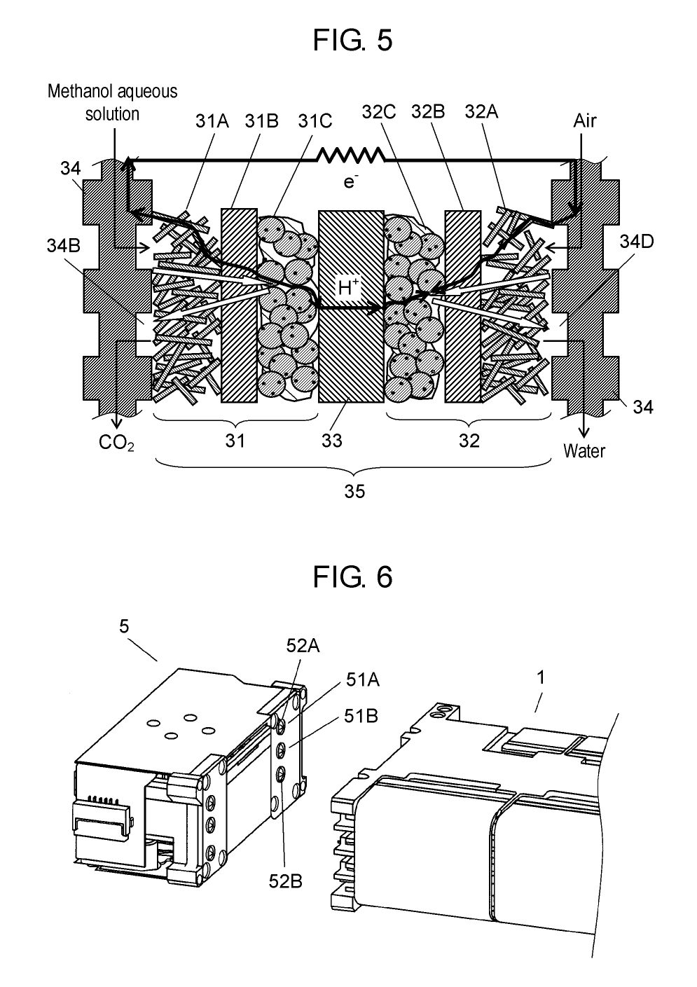

FIG. 1 is a block diagram showing a configuration of a fuel cell system in accordance with the embodiment of the present invention. FIGS. 2A and 2B are perspective views of a fuel cell stack in accordance with the embodiment of the present invention. FIG. 2A is a perspective view seen from a first side surface side, and FIG. 2B is a perspective view seen from a third side surface side that is the opposite side to the first surface. FIG. 3 is a plan view of a surface (first surface), which faces a cathode electrode, of a separator used in the fuel cell stack shown in FIGS. 2A and 2B. FIG. 4 is a plan view of a surface (second surface), which faces an anode electrode, of the separator used in the fuel cell stack. FIG. 5 is a conceptual sectional view showing an outline configuration of a principal part of the fuel cell stack.

As shown in FIG. 1, the fuel cell system includes fuel cell stack 1, fuel tank 4, fuel pump 5, air pump 6, controller 7, storage section 8, and DC/DC converter 9. Fuel cell stack 1 has an electricity generation section, and generated electric power is output from positive electrode terminal 2 and negative electrode terminal 3. The output electric power is input into DC/DC converter 9. Fuel pump 5 supplies fuel in fuel tank 4 to anode electrode 31 of fuel cell stack 1. Air pump 6 supplies air as an oxidizing agent to cathode electrode 32 of fuel cell stack 1. Controller 7 controls the driving of fuel pump 5 and air pump 6 and controls DC/DC converter 9 so as to control the output to the outside and the charge and discharge with respect to storage section 8. Fuel tank 4, fuel pump 5 and controller 7 constitute a fuel supply section for supplying fuel to anode electrode 31 in fuel cell stack 1. On the other hand, air pump 6 and controller 7 constitute a gas supply section for supplying gas containing an oxidizing agent to cathode electrode 32 in fuel cell stack 1. Note here that the fuel supply section and the gas supply section are not necessarily limited to this configuration.

As shown in FIGS. 2A and 2B, fuel cell stack 1 includes cell stack 16, backing plates 14 and 15, first plate spring 11 and second plate spring 12. Cell stack 16 includes membrane electrode assemblies (hereinafter, referred to as “MEAs”) 35 as the electricity generation sections shown in FIG. 5, separators 34 disposed so as to sandwich each MEA 35, anode-side end plate 17 and cathode-side end plate 18 (hereinafter, both are referred to as an “end plate”). End plates 17 and 18 sandwich MEAs 35 and separators 34 from both sides in the direction in which MEA 35 are made by laminating, that is, from both sides in the direction in which MEAs 35 and separators 34 are laminated.

As shown in FIG. 5, MEA 35 is formed by laminating anode electrode 31, cathode electrode 32, and electrolyte membrane 33 interposed between anode electrode 31 and cathode electrode 32. Anode electrode 31 is supplied with a methanol aqueous solution as fuel, and cathode electrode 32 is supplied with air.

Anode electrode 31 includes diffusion layer 31A, microporous layer (hereinafter, referred to as “MPL”) 31B and catalyst layer 31C, which are laminated sequentially from the separator 34 side. Cathode electrode 32 also includes diffusion layer 32A, microporous layer (hereinafter, referred to as “MPL”) 32B and catalyst layer 32C, which are laminated sequentially from the separator 34 side. Positive electrode terminal 2 is electrically connected to cathode electrode 32, and negative electrode terminal 3 is electrically connected to anode electrode 31, respectively. Diffusion layers 31A and 32A are made of, for example, carbon paper, carbon felt, carbon cloth, or the like. MPLs 31B and 32B are made of, for example, polytetrafluoroethylene or a tetrafluoroethylene-hexafluoropropylene copolymer, and carbon. Catalyst layers 31C and 32C are formed by highly diffusing a catalyst such as platinum and ruthenium suitable for each electrode reaction onto a carbon surface and by binding this catalyst with a binder. Electrolyte membrane 33 is formed of an ion-exchange membrane for allowing a hydrogen ion to permeate, for example, a perfluorosulfonic acid—tetrafluoroethylene copolymer.

End plates 17 and 18 and separator 34 are made of a carbon material or stainless steel. As shown in FIG. 5, separator 34 has a surface (first surface) that faces cathode electrode 32, and a surface (second surface) that faces anode electrode 31 at the rear side of the first surface. Furthermore, as shown in FIGS. 3 and 4, separator 34 has a rectangular shape, and includes first edge 134, second edge 234 that is adjacent to first edge 134, third edge 334 that faces first edge 134 and is adjacent to second edge 234, and fourth edge 434 that faces second edge 234.

As shown in FIG. 3, the first surface of separator 34 has gas inlets (hereinafter, referred to as “inlets”) 343A and 343B, inlet chamber 345, first outlet 344A, second outlet 344B, outlet chamber 346, a plurality of linear partition walls 34E, and center partition wall 34H. Inlets 343A and 343B configured to take in air that is oxygen-containing gas as an oxidizing agent are provided on first edge 134. Inlet chamber 345 is linked to inlets 343A and 343B. First outlet 344A is provided on second edge 234, and second outlet 344B is provided on fourth edge 434. Outlet chamber 346 is linked to first outlet 344A and second outlet 344B.

Partition walls 34E are provided in parallel to each other in the direction from first edge 134 to third edge 334, and center partition wall 34H is provided in parallel to partition walls 34E at the center position, in the direction from first edge 134 to third edge 334. Partition walls 34E have substantially the same length. Each two of partition walls 34E, or center partition wall 34H and two partition walls 34E neighboring center partition wall 34H form a plurality of linear passages 34D having the same width, which are linked between inlet chamber 345 and outlet chamber 346 along the direction from first edge 134 to third edge 334.

A space is provided between center partition wall 34H and an inner wall surface of third edge 334, and first outlet 344A and second outlet 344B communicate with each other via the space. If center partition wall 34H is linked to third edge 334 to divide outlet chamber 346 into two portions, produced water does not easily flow out from one of the divided portions of outlet chamber 346 when fuel cell stack 1 is inclined. However, thanks to the structure in which a space is provided between center partition wall 34H and third edge 334, produced water can be exhausted from any of first outlet 344A and second outlet 344B. Therefore, the produced water does not remain in outlet chamber 346 and does not close the passage. Thus, even when fuel cell stack 1 is disposed in such a manner that second edge 234 is positioned higher than fourth edge 434 or second edge 234 is positioned lower than fourth edge 434 positioned, water is not accumulated in a corner portion formed by center partition wall 34H and third edge 334. The water flows in the direction of the gravity through the space between center partition wall 34H and third edge 334. In this way, water is exhausted from any one of first outlet 344A provided on second edge 234 and second outlet 344B provided on fourth edge 434. Therefore, even when fuel cell stack 1 is placed on an inclined place, stable electric generation can be maintained.

It is preferable that the plurality of partition walls 34E are disposed to be displaced with respect to each other in the direction from first edge 134 to third edge 334 such that outlet chamber 346 is the smallest (narrowest) at the center portion of third edge 334 and gradually becomes larger toward first outlet 344A and second outlet 344B, respectively. That is to say, the plurality of partition walls 34E are formed so as to sandwich center partition wall 34H in substantially an equal interval and in substantially the same length, and form a plurality of linear passages 34D together with center partition wall 34H. It is preferable that outlet chamber 346 is formed at the end side of partition walls 34E and center partition wall 34H, and that outlet chamber 346 is widened in the direction toward first outlet 344A and second outlet 344B.

Similarly, a cathode-facing surface of cathode-side end plate 18 has gas inlets (hereinafter, referred to as “inlet”) 183A and 183B, inlet chamber 185, first outlet 184A, second outlet 184B, outlet chamber 186, a plurality of linear partition walls 18E, and center partition wall 18H. Inlets 183A and 183B are provided on first edge 118, and inlet chamber 185 is linked to inlets 183A and 183B. First outlet 184A is provided on second edge 218, and second outlet 184B is provided on fourth edge 418. Outlet chamber 186 is linked to first outlet 184A and second outlet 184B.

Partition walls 18E are provided in parallel to each other in the direction from first edge 118 to third edge 318, and center partition wall 18H is provided in parallel to partition walls 18E at the center position, in the direction from first edge 118 to third edge 318. Partition walls 18E have substantially the same length. Each two of partition walls 18, and center partition wall 18H and two partition walls 18E neighboring center partition wall 18H form a plurality of linear passages 18D having the same width, which are linked between inlet chamber 185 and outlet chamber 186 along the direction from first edge 118 to third edge 318. A space is provided between center partition wall 18H and an inner wall surface of third edge 318, and first outlet 184A and second outlet 184B communicate with each other via the space.

It is preferable that the plurality of partition walls 18E are disposed to be displaced with respect to each other in the direction from first edge 118 to third edge 318 such that outlet chamber 186 is the smallest at the center portion of third edge 318 and gradually becomes larger toward first outlet 184A and second outlet 184B. That is to say, the plurality of partition walls 18E are formed so as to sandwich center partition wall 18H in substantially an equal interval and in substantially the same length, and form a plurality of linear passages 18D together with center partition wall 18H. It is preferable that outlet chamber 186 is formed at the end side of partition walls 18E and center partition wall 18H, and that outlet chamber 186 is widened in the direction toward first outlet 184A and second outlet 184B.

As shown in FIGS. 2A and 2B, inlet 343A and inlet 183A, inlet 343B and inlet 183B, first outlet 344A and first outlet 184A, as well as second outlet 344B and second outlet 184B are formed in corresponding positions, respectively. That is to say, first edge 134 and first edge 118, second edge 234 and second edge 218, third edge 334 and third edge 318, as well as fourth edge 434 and fourth edge 418 are disposed in the positions corresponding to each other.

Inlets 343A, 343B, 183A, and 183B are provided on the first side surface of cell stack 16 on which first plate spring 11 and second plate spring 12 are not placed. The first side surface is parallel to the laminate direction. The first side surface includes first edges 134 and 118. On the other hand, first outlets 344A and 184A are provided on the second side surface on which first plate springs 11 are applied. The second side surface includes second edges 234 and 218. Furthermore, second outlets 344B and 184B are provided on the fourth side surface on which second plate springs 12 dare applied. The fourth side surface includes fourth edges 434 and 418.

On the other hand, as shown in FIG. 4, on a second surface of separator 34, fuel passage 34B for supplying fuel to anode electrode 31 is formed in a groove shape. Fuel passage 34B at a first end is linked to fuel inlet 341 formed on plane portion 34A via through hole 34C as shown in FIG. 2B. On the other hand, fuel passage 34B at a second end is linked to fuel outlet 342 on first edge 134. At least one of a reaction product of fuel and a reaction residue of fuel is exhausted from fuel outlet 342.

Also on an anode-facing surface of anode-side end plate 17, similar to FIG. 4, fuel passage 17B for supplying fuel to anode electrode 31 is formed in a groove shape. Fuel passage 17B at a first end is linked to fuel inlet 171 formed on plane portion 17A via through hole 17C. On the other hand, fuel passage 17B at a second end is linked to fuel outlet 172 on first edge 134. At least one of a reaction product of fuel and a reaction residue of fuel is exhausted from fuel outlet 172.

As shown in FIG. 2B, plane portions 17A and 34A are parallel to the laminate direction and are provided on a third side surface on which first plate spring 11 and second plate spring 12 are not placed and which is opposite to the first side surface provided with inlets 343A, 343B, 183A, and 183B. The third side surface includes third edges 334 and 318.

The dimension of plane portions 34A and 17A in the laminating direction is larger than the thickness of a portion of separator 34 where separators 34 sandwich MEA 35 separator 34 and anode-side end plate 17 sandwich MEA 35.

Backing plate 14 is disposed at the anode electrode 31 side in cell stack 16, and backing plate 15 is disposed at the cathode electrode 32 side. Backing plates 14 and 15 are made of electrically-insulating resin, ceramic, or resin containing a glass fiber, a metal plate coated with an electrically-insulating membrane, or the like.

First plate spring 11 and second plate spring 12 fasten cell stack 16 with the spring elastic force thereof via backing plates 14 and 15. Second plate spring 12 is disposed so as to face first plate spring 11. First plate spring 11 and second plate spring 12 are made of, for example, a spring steel material.

Next, an operation in fuel cell stack 1 is briefly described. As shown in FIGS. 1 and 5, anode electrode 31 is supplied with an aqueous solution containing methanol by fuel pump 5. On the other hand, cathode electrode 32 is supplied with air pressurized by air pump 6. A methanol aqueous solution as a fuel supplied to anode electrode 31, and methanol and water vapor derived therefrom are diffused through diffusion layer 31A to the entire surface of MPL 31B. These further pass through MPL 31B and reach catalyst layer 31C.

On the other hand, oxygen contained in the air supplied to cathode electrode 32 is diffused through diffusion layer 32A to the entire surface of MPL 32B. The oxygen further passes through MPL 32B and reaches catalyst layer 32C. Methanol that reaches catalyst layer 31C reacts as in formula (1), and oxygen that reaches catalyst layer 32C reacts as in formula (2).

CH₃OH+H₂O→CO₂+6H⁺+6e⁻ (1)

3/2O₂+6H⁺+6e⁻→3H₂O (2)

As a result, electric power is generated, as well as carbon dioxide is generated at the anode electrode 31 side, and water is generated at the cathode electrode 32 side as reaction products, respectively. Carbon dioxide is exhausted from fuel outlets 172 and 342 to the outside of fuel cell stack 1. Gases such as nitrogen that do not react in cathode electrode 32 and unreacted oxygen are also exhausted to the outside of fuel cell stack 1. Note here that since not all methanol in the aqueous solution react at the anode electrode 31 side, the exhausted aqueous solution is generally allowed to return to fuel pump 5 as shown in FIG. 1. Furthermore, since water is consumed in the reaction in anode electrode 31, water generated in cathode electrode 32 may be allowed to return to the anode electrode 31 side as shown in FIG. 1.

In the embodiment, cell stack 16 is fastened by first plate spring 11 and second plate spring 12 via backing plates 14 and 15. First plate spring 11 and second plate spring 12 fasten cell stack 16 extremely compactly along the outer shape of cell stack 16 as shown in FIGS. 2A and 2B. That is to say, dead space is extremely reduced in size on the side surfaces of cell stack 16, and fuel cell stack 1 can be reduced in size as compared with the case in which fastening is carried out by using bolts and nuts as in a conventional case.

Furthermore, in a case in which bolts and nuts are used for fastening, a pressing point is provided at the outside of cell stack 16. However, first plate spring 11 and second plate spring 12 have a pressing point in a relatively central portion in cell stack 16. Therefore, pressing power works in cell stack 16 uniformly in the planar direction of backing plates 14 and 15. With such a pressing power, entire cell stack 16 can be fastened uniformly. Thus, the electrochemical reactions expressed by the formulae (1) and (2) proceed uniformly in the planar direction of MEA 35. As a result, current-voltage characteristics of fuel cell stack 1 are improved.

Next, an effect of a passage structure provided on a first surface of separator 34 and a cathode facing surface of cathode-side end plate 18 is described. Herein, as a representative example, separator 34 is described. As mentioned above, partition walls 34E and center partition wall 34H form a plurality of linear passages 34D having substantially the same width, which are linked between inlet chamber 345 and outlet chamber 346 along the direction from first edge 134 to third edge 334. Therefore, the main direction in which air flows is linear one direction. That is to say, bending portions are reduced so as to increase the total cross-sectional area, and thus to reduce a pressure loss as compared with a serpentine-shaped passage. Moreover, even when water as a reaction product is generated inside linear passages 34D, it easily moves toward outlet chamber 346 by the air supplied from inlet chamber 345.

Furthermore, a plurality of partition walls 34E have substantially the same length. Therefore, linear passages 34D other than those neighboring center partition wall 34H have substantially the same length, and the air resistance is also substantially the same. Therefore, substantially the same amount of air flows in each linear passage 34D. As a result, in the direction parallel to first edge 134, air can be supplied uniformly.

Moreover, the plurality of partition walls 34E are disposed to be displaced with respect to each other in the direction from first edge 134 to third edge 334 such that outlet chamber 346 becomes larger gradually toward first outlet 344A and second outlet 344B. Therefore, in outlet chamber 346, since the air resistance is reduced from the center portion of third edge 334 toward first outlet 344A and second outlet 344B, and the direction toward first outlet 344A or second outlet 344B is the same direction in each linear passage 34D, smooth air flow can be formed. Therefore, produced water can be allowed to flow to first outlet 344A or second outlet 344B with a small air flow pressure.

It is preferable that the distance by which two of neighboring partition walls 34E in the plurality of partition walls 34E are displaced from each other in the direction from first edge 134 to third edge 334 is constant. Thus, the end portions of partition walls 34E at the outlet chamber 346 side are linearly aligned. Therefore, a cross-sectional area of outlet chamber 346 is in proportion to the moving distance from the center portion of third edge 334 to first outlet 344A or second outlet 344B. As mentioned above, air flows in each linear passage 34D in substantially the same air volume. Therefore, outlet chamber 346 can receive such exhausted gas smoothly.

As shown in FIG. 3, inlet 343A and inlet 343B are separately provided at first edge 134. Therefore, fuel outlet 342 and inlets 343A and 343B are not overlapped with each other, so that introduction of air into cell stack 16 and outflow of exhausted gas at the fuel side from cell stack 16 can be easily separated from each other. Moreover, by dividing inlets 343A and 343B further separately, a pressure loss at inlet chamber 345 can be reduced. However, when the size of fuel cell stack 1 is small, one each of inlets 343A and 343B may be provided.

Furthermore, as shown in FIG. 3, center partition wall 34H is linked to the inner wall surface of first edge 134 such that inlet chamber 345 is divided into a first inlet chamber and a second inlet chamber at the center part of first edge 134. First inlet 343A and second inlet 343B are linked to the first inlet chamber and the second inlet chamber, respectively. In this configuration, even when first edge 134 is long, air can be supplied uniformly to the entire of inlet chamber 345. However, when the size of fuel cell stack 1 is small, center partition wall 34H may not be linked to the inner wall surface of first edge 134, and the number of gas inlet may be one.

Furthermore, protrusions 34F are provided in inlet chamber 345. Protrusion 34F promotes diffusion of air entering from inlets 343A and 343B inside inlet chamber 345. Therefore, substantially the same amount of air can be allowed to flow in each linear passage 34D reliably.

Furthermore, protrusions 34G are provided in outlet chamber 346. Protrusion 34G promotes flow of water generated in linear passages 34D and pushed out from linear passages 34D toward first outlet 344A or second outlet 344B in outlet chamber 346. That is to say, when a water droplet attached to one protrusion 34G expands (extends) toward a downstream side (outlet side) by an air flow pressure, it is brought into contact with next protrusion 34G and moves easily between protrusions 34G.

Furthermore, similar to partition walls 34E, when protrusions 34F and 34G are formed at such a height that they are brought into contact with cathode electrode 32, a conducting area between MEAs 35 is increased, which is advantageous in terms of current collection.

Also in cathode-side end plate 18, similarly, protrusions 18F are provided in inlet chamber 185, and protrusions 18G are provided in outlet chamber 186.

Furthermore, it is preferable that the surfaces of protrusions 34G, 18G and partition walls 34E are treated to have a hydrophilic property. Thus, the produced water is not easily formed into a spherical water droplet, and the produced water can be easily exhausted.

Next, connection between fuel cell stack 1 and fuel pump 5 is described with reference to FIGS. 2B and 6. FIG. 6 is a perspective view illustrating connection between fuel cell stack 1 shown in FIG. 2 and fuel pump 5 shown in FIG. 1.

As shown in FIG. 2B, plane portions 17A and 34A are formed on the third side surface to be connected to fuel pump 5. In fuel pump 5, fuel discharging section 51A is provided on a position corresponding to plane portion 17A, and each of fuel discharging sections 51B is provided on a position corresponding to respective one of plane portions 34A. On fuel discharging section 51A, seal member 52A is disposed. Similarly, on each of fuel discharging sections 51B, seal member 52B is disposed. Seal members 52A and 52B are formed smaller in size than plane portions 17A and 34A, respectively. Fuel inlet 171 and fuel discharging section 51A are allowed to face each other, and each of fuel inlets 341 and respective one of fuel discharging sections 51B are allowed to face each other. Furthermore, fuel pump 5 and fuel cell stack 1 are fastened by, for example, a bolt so that seal members 52A and 52B are compressed by plane portions 17A and 34A. Thereby, a fuel passage is sealed.

With this structure, even if thin anode-side end plate 17 and separator 34 are used, by securely carrying out sealing with the use of plane portions 17A and 34A, the fuel cell stack can be connected to fuel pump 5. This makes it possible to prevent fuel from leaking at the connection portions.

As shown in FIG. 2B, it is preferable that plane portion 17A and plane portion 34A or plane portions 34A are displaced from each other in the direction perpendicular to the laminating direction. FIG. 2B shows that plane portions 17A and 34A are provided alternately in the laminating order. With such a position relation, plane portion 17A and plane portion 34A, or plane portions 34A are not brought into contact with each other. Consequently, it is possible to prevent short circuit in cell stack 16. Furthermore, the degree of freedom in disposing of fuel discharging sections 51A and 51B is obtained.

Furthermore, it is further preferable that plane portion 17A and plane portion 34A or plane portions 34A are provided on the same plane. By providing plane portion 17A and plane portion 34A on the same plane in which they are displaced from each other in the direction perpendicular to the laminating direction, fuel discharging sections 51A and 51B may be provided on the same plane. Thus, fuel discharging sections 51A and 51B can be sealed, reliably.

Furthermore, it is preferable that fuel pump 5 is capable of individually controlling the flow rates of fuel discharged from fuel discharging sections 51A and 51B, respectively. By using such a fuel pump 5, it is possible to supply fuel to each unit cell at an optimum flow rate. Since there is a variation in the electromotive force and/or a pressure loss of a flow passage among unit cells, it is preferable that the flow rate of the fuel is controlled for each unit cell.

Thus, fuel pump 5 forming a fuel supply section is attached to the third side surface including third edge 318 of cathode-side end plate 18 and third edge 334 of separator 34. Accordingly, a fuel cell system can be reduced in size. In the above description, an example is described in which fuel inlets 341 and 171 are provided in plane portions 34A and 17A. However, a fuel pump may be connected to a fuel passage by any other configurations. For example, a through hole is provided in the thickness direction of separator 34 from through hole 34C connected to fuel passage 34B, and these through-holes are allowed to communicate with each other in the laminating direction of cell stack 16. Then, fuel may be supplied from a fuel pump to the thus formed communicating tube. Such a configuration is possible because neither gas inlet nor gas outlet is provided on the third edge 334 side. In any case, when a fuel inlet is provided on the third side surface side and fuel pump 5 is disposed on the third side surface side, a fuel cell system can be reduced in size.

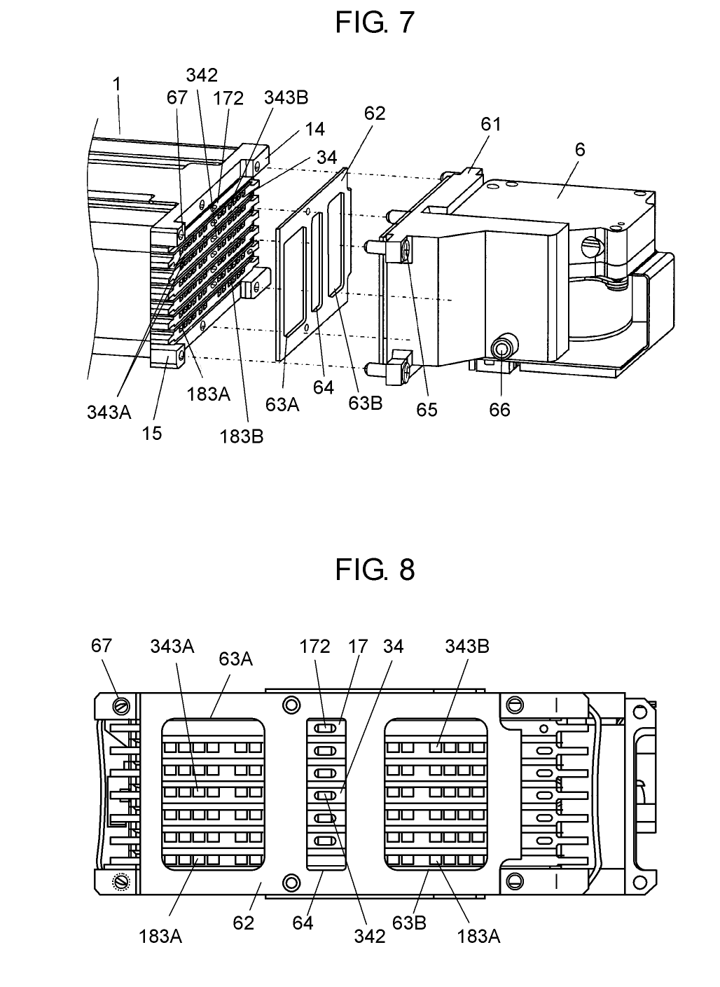

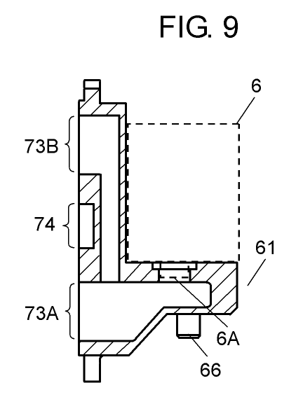

Next, the connection between fuel cell stack 1 and air pump 6 is described with reference to FIGS. 2A and 7 to 9. FIG. 7 is a perspective view illustrating the connection between fuel cell stack 1 shown in FIG. 2 and air pump 6 shown in FIG. 1. FIG. 8 is a front view showing a first side surface of fuel cell stack 1. FIG. 9 is a sectional view showing integrated member 61 to be attached to the first side surface.

Air pump 6 forming a gas supply section has gas discharging section 6A as shown in FIG. 9 and is attached to integrated member 61 by bolt 66 as shown in FIG. 7. Integrated member 61 includes gas discharging sections 73A and 73B and receiver section 74. Gas discharging section 6A communicates with gas discharging section 73A of integrated member 61, and gas discharging section 73A communicates with gas discharging section 73B. Receiver section 74 is configured to receive exhausted gas from fuel outlets 172 and 342. Receiver section 74 is a hollow structure, and communicates with an exhaust pipe (not shown) provided in the lower part. In this way, integrated member 61 is formed by integrating gas discharging sections 73A and 73B configured to supply air sent from air pump 6 to inlets 183A, 183B, 343A, and 343B and receiver section 74 configured to receive exhausted gas from fuel outlets 172 and 342.

On the other hand, seal member 62 is attached to the first side surface of cell stack 16 as shown in FIGS. 7 and 8. The first side surface is provided with inlets 183A, 183B, 343A, and 343B as well as fuel outlets 172 and 342. Seal member 62 is provided with opening 63A at the position corresponding to inlets 183A and 343A, and opening 63B at the position corresponding to fuel inlets 183B and 343B. On the other hand, seal member 62 is provided with opening 64 at the position corresponding to fuel outlets 172 and 342.

Integrated member 61 is attached to fuel cell stack 1 with seal member 62 sandwiched therebetween by screwing screws 65 into screw holes 67 provided on backing plates 14 and 15. In this state, seal member 62 separates inlets 183A, 183B, 343A, and 343B from fuel outlets 172 and 342. Furthermore, seal member 62 connects gas discharging section 73A to inlets 183A and 343A, gas discharging section 73B and inlets 183B and 343B, respectively. Therefore, air sent from air pump 6 is supplied to inlets 183A, 183B, 343A, and 343B. Furthermore, seal member 62 binds receiver section 74 to fuel outlets 172 and 342.

By using integrated member 61 and seal member 62 in this way, an air introducing passage and a fuel side exhaust passage can be formed on the first side surface in compact in size. As a result, a fuel cell system can be reduced in size.

In the above description, a configuration is described in which a plurality of MEAs 35 are used and separator 34 is interposed between MEAs 35, end plates 17 and 18 are disposed on both ends in the laminating direction so as to form cell stack 16, and backing plates 14 and 15 are further disposed on the outside end plates 17 and 18. However, the present invention is not limited to this configuration. A single MEA 35 may be sandwiched by end plates 17 and 18 from the both sides in the laminating direction, and MEA 35 and end plates 17 and 18 may be fastened in the laminating direction in MEA 35 by only first plate spring 11. In this case, it is preferable that first plate spring 11 is formed so as to press the vicinity of the center part of end plates 17 and 18. Needless to say, in this configuration, second plate spring 12 may further be used. Furthermore, in FIGS. 2A and 2B, a plurality of first plate springs 11 and second plate springs 12 are used. However, one first plate spring 11 and one second plate spring 12 may be used depending upon the size of cell stack 16. Thus, the subject to be pressed may be a single cell or a cell stack. One plate spring may be used and a plurality of or a pair of or a plurality of pairs of plate springs may be used.

Furthermore, without using backing plates 14 and 15, end plates 17 and 18 may be directly sandwiched by first plate spring 11 and second plate spring 12. In this case, an insulating film is formed inside the C-shaped cross section of each of first plate spring 11 and second plate spring 12 so that first plate spring 11 does not cause short circuit. Furthermore, fastening sections (for example, screw hole 67) between fuel pump 5 and integrated member 61 are provided on end plates 17 and 18. That is to say, backing plates 14 and 15 are not essential.

However, it is preferable that backing plates 14 and 15 are provided and that backing plates 14 and 15 are formed of different materials from those of end plates 17 and 18. Thus, it is possible to optimize backing plates 14 and 15 that directly receive a pressing force of first plate spring 11, and end plates 17 and 18 that also function as flow passages of fuels and air. For example, by forming backing plates 14 and 15 with materials harder than end plates 17 and 18, it is possible to suppress the deformation of backing plates 14 and 15 due to the pressing force of first plate spring 11. As a result, a unit cell of fuel cell or a cell stack can be fastened more uniformly in the planner direction of MEA 35. Furthermore, by forming backing plates 14 and 15 with an insulating material, it is not necessary to consider short circuit due to arm sections of first plate spring 11.

In this embodiment, cell stack 16 is fastened by using first plate spring 11 and second plate spring 12, and fuel and air are supplied from facing side surfaces that are not fastened by first plate spring 11 and second plate spring 12. However, the present invention is not limited to this configuration. When second plate spring 12 is not used, a side surface, which is covered with second plate spring 12 in this embodiment, may be used for supplying fuel and air. Furthermore, when a pair of backing plates are fastened by, for example, a bolt, without using first plate spring 11 and second plate spring 12, any side surfaces may be used for supplying fuel and air.

In the embodiment, DMFC is described as an example. However, the configuration of the present invention can be applied to any fuel cells using a power generation element that is the same as cell stack 16. For example, the configuration of the present invention may be applied to a so-called polymer solid electrolyte fuel cell and a methanol modified fuel cell, which use hydrogen as fuel. However, DMFC is operated at a relatively low temperature and produced water is easily aggregated in the passage. Therefore, the present invention is particularly effective in DMFC.

In the above description, inlets 183A and 183B are formed on first edge 118 of end plate 17, first outlet 184A is formed on second edge 218, and second outlet 184B is formed on fourth edge 418. Similarly, inlets 343A and 343B are formed on first edge 134 of separator 34, first outlet 344A is formed on second edge 234, and second outlet 344B is formed on fourth edge 434. These inlet and outlets faces out sides of cell stack 16 on the respective edges. However, the present invention is not limited to this structure. In other words, it is not necessary to provide the gas inlets on the first edge, the first outlet on the second edge, and the second outlet on the fourth edge. For example, a gas inlet can be formed as a through hole extending along a thickness direction of end plate 18 and separator 34 at a vicinity of each of the first edges. In this case, a tube is inserted in the through holes so that the cathode-facing surface of end plate 18 and the first surface of each of separator 34 communicate to each other, the tube is extended to the underside of cell stack 16 and gas including oxidant can be supplied from the extended portion. The first and second outlets can be formed in the same manner. Thus, it is acceptable that the gas inlets are provided at the first edge sides, the second outlets are provided at the second edge sides, and the second outlets are provided at the fourth edge sides.

As mentioned above, separator 34 includes a first surface configured to face cathode electrode 32 and a second surface provided on a rear side of the first surface and configured to face anode electrode 31. Furthermore, separator 34 includes first edge 134, second edge 234 that is adjacent to first edge 134, third edge 334 that faces first edge 134 and is adjacent to second edge 234, and fourth edge 434 that faces second edge 234 so that separator 34 is defined of a first edge side along first edge 134, a second edge side along second edge 234, a third edge side along third edge 334, and a fourth edge side along fourth edge 434. The first surface includes inlets 343A and 343B provided at the first edge 134 side, inlet chamber 345, first outlet 344A provided at the second edge 234 side, second outlet 344B provided at the fourth edge 434 side, outlet chamber 346, a plurality of linear partition walls 34E, and center partition wall 34H. Inlet chamber 345 is linked to inlets 343A and 343B, and outlet chamber 346 is linked to first outlet 344A and second outlet 344B.

Partition walls 34E are provided in parallel to each other in the direction from first edge 134 to third edge 334, and center partition wall 34H is provided in parallel to partition walls 34E at the center position, in the direction from first edge 134 to third edge 334. A plurality of partition walls 34E have substantially the same length. Each two of partition walls 34E, or center partition wall 34H and two partition walls 34E neighboring center partition wall 34H form a plurality of linear passages 34D having the same width and being linked between inlet chamber 345 and outlet chamber 346 along the direction from first edge 134 to third edge 334. A space is provided between center partition wall 34H and an inner wall surface of third edge 334, and first outlet 344A and second outlet 344B communicate with each other via the space. Thus, regardless of the inclined direction of fuel cell stack 1, water produced from the entire first surface can be exhausted from at least one of first outlet 344A and second outlet 344B.

Furthermore, it is preferable that partition walls 34E are disposed to be displaced with respect to each other in the direction from first edge 134 to third edge 334 such that outlet chamber 346 is the smallest at the center portion of third edge 334 and it gradually becomes larger toward first outlet 344A and second outlet 344B.

With this passage configuration, even with a small air flow pressure, produced water can be smoothly exhausted from linear passage 34D by the flow of air. Accordingly, the reduction of output due to closing of the passage by the produced water can be suppressed. Alternatively, an operation can be carried out with a small flowing pressure.

It is preferable that the distance by which two neighboring partition walls 34E in the plurality of partition walls 34E are displaced in the direction from first edge 134 toward third edge 334 is constant. Thus, the flow of air becomes smoother.

Furthermore, it is preferable that a plurality of inlets 343A and 343B are provided at first edge 134 and are linked to inlet chamber 345. Thus, air can be easily blown to each linear passage 34D more uniformly.

Furthermore, it is preferable that center partition wall 34H is linked to the inner wall surface of first edge 134 so that inlet chamber 345 is divided into a first inlet chamber and a second inlet chamber at the center portion of first edge 134, and inlets 343A and 343B are linked to the first inlet chamber and the second inlet chamber, respectively. Thus, air can be easily blown to each linear passage 34D more uniformly.

Furthermore, the fuel cell stack includes cathode-side end plate 18, membrane electrode assembly 35, and anode-side end plate 17. Membrane electrode assembly 35 is formed by laminating cathode electrode 32, electrolyte membrane 33 and anode electrode 31 to each other. Cathode electrode 32 faces cathode-side end plate 18, and anode electrode 31 is provided at the rear side with respect to cathode electrode 32. Electrolyte membrane 33 is interposed between cathode electrode 32 and anode electrode 31. Cathode-side end plate 18 has a passage configuration similar to that of the first surface of the above-mentioned separator 34 on a cathode-facing surface that faces cathode electrode 32. With this configuration, produced water can be exhausted smoothly by an air flow passage structure formed in cathode-side end plate 18.

Furthermore, the fuel cell system according to this embodiment includes the above-mentioned fuel cell stack, a fuel supply section including fuel pump 5, and a gas supply section including air pump 6. Fuel passage 17B is provided on a surface of anode-side end plate 17, which faces anode electrode 31, and fuel inlet 171 linked to fuel passage 17B is provided on the edge side corresponding to the third edge 318 side of cathode-side end plate 18. The fuel supply section is disposed on the surface side including third edge 318 of cathode-side end plate 18 of the fuel cell stack and supplies fuel to fuel inlet 171 of anode-side end plate 17. The gas supply section supplies gas that contains an oxidizing agent to inlets 343A and 343B of cathode-side end plate 18. With this configuration, in addition to the effect of the above-mentioned fuel cell stack, a fuel cell system can be reduced in size.

Alternatively, fuel cell stack 1 includes, in addition to the above-mentioned configuration, first and second membrane electrode assemblies 35, and separator 34 inserted between first and second membrane electrode assemblies 35. The configuration of separator 34 is the same as mentioned above. That is to say, separator 34 includes first edge 134, second edge 234 and third edge 334 in positions corresponding to first edge 118, second edge 218 and third edge 318 of cathode-side end plate 18, respectively. In this configuration, with an air passage structure formed on separator 34 or cathode-side end plate 18, produced water can be exhausted smoothly.

Furthermore, also in a fuel cell system using fuel cell stack 1, in addition to the above-mentioned effect of fuel cell stack 1, the fuel cell system can be reduced in size.

As mentioned above, in the fuel cell stack and the fuel cell system using the fuel cell separator of the present invention, a liquid product at the cathode electrode side can be exhausted from at least one of the first outlet and the second outlet regardless of the inclined direction of the fuel cell stack. Therefore, the reduction of output due to closing of the passage by the produced water can be suppressed. Alternatively, an operation can be carried out with a small flowing pressure. Such a fuel cell stack and a fuel cell system using the same are useful as power sources for small electronic devices.

What is claimed is:

1. A fuel cell separator comprising:
a first surface configured to face a cathode electrode; and
a second surface provided on a rear side of the first surface and configured to face an anode electrode,
wherein the separator includes a first edge, a second edge that is adjacent to the first edge, a third edge that faces the first edge and is adjacent to the second edge, and a fourth edge that faces the second edge, so that the separator is defined of a first edge side along the first edge, a second edge side along the second edge, a third edge side along the third edge, and a fourth edge side along the fourth edge,
wherein the first surface includes:
an inlet provided at the first edge side,
an inlet chamber linked to the inlet,
a first outlet provided at the second edge side,
a second outlet provided at the fourth edge side,
an outlet chamber linked to the first outlet and the second outlet,
a plurality of linear partition walls provided in parallel to each other in a direction from the first edge to the third edge, and
a center partition wall provided in parallel to the plurality of linear partition walls at a center position, in the direction from the first edge to the third edge,
wherein the plurality of partition walls have a same length, and each two of the plurality of partition walls, and the center partition wall and two of the plurality of partition walls neighboring the center partition wall form a plurality of linear passages having a same width and being linked between the inlet chamber and the outlet chamber along the direction from the first edge to the third edge, and
wherein a space is provided between the center partition wall and an inner wall surface of the third edge, and the first outlet and the second outlet communicate with each other via the space.

2. The fuel cell separator according to claim 1,
wherein the plurality of partition walls are disposed to be displaced with respect to each other in the direction from the first edge to the third edge such that the outlet chamber is smallest at a center portion of the third edge and is gradually larger toward the first outlet and the second outlet.

3. The fuel cell separator according to claim 2,
wherein a distance by which two neighboring partition walls in the plurality of partition walls are displaced with respect to each other is constant.

4. The fuel cell separator according to claim 1,
wherein the inlet is one of a plurality of inlets, and the plurality of inlets are provided on the first edge and linked to the inlet chamber.

5. The fuel cell separator according to claim 1,
wherein the inlet is one of a plurality of inlets, and the plurality of inlets are provided on the first edge, and
the center partition wall is linked to an inner wall surface of the first edge so that the inlet chamber is divided into a first inlet chamber and a second inlet chamber at a center portion of the first edge, and each of the plurality of inlets are linked to one of the first inlet chamber and the second inlet chamber.

6. A fuel cell stack comprising;
a cathode-side end plate;
a membrane electrode assembly formed by laminating a cathode electrode that faces the cathode-side end plate, an anode electrode provided on a rear side of the cathode electrode, and an electrolyte membrane interposed between the cathode electrode and the anode electrode to each other; and
an anode-side end plate that faces the anode electrode,
wherein the cathode-side end plate includes a first edge, a second edge that is adjacent to the first edge, a third edge that faces the first edge and is adjacent to the second edge, and a fourth edge that faces the second edge, on a cathode-facing surface that faces the cathode electrode, so that the cathode-side end plat is defined of a first edge side along the first edge, a second edge side along the second edge, a third edge side along the third edge, and a fourth edge side along the fourth edge,
wherein the cathode-facing surface includes;
an inlet provided at the first edge side,
an inlet chamber linked to the inlet,
a first outlet provided at the second edge side,
a second outlet provided at the fourth edge side,
an outlet chamber linked to the first outlet and the second outlet,
a plurality of linear partition walls provided in parallel to each other in a direction from the first edge to the third edge, and
a center partition wall provided in parallel to the plurality of linear partition walls at a center position, in the direction from the first edge to the third edge,
wherein the plurality of partition walls have a same length, and each two of the plurality of partition walls, and the center partition wall and two of the plurality of partition walls neighboring the center partition wall form a plurality of linear passages having a same width and being linked between the inlet chamber and the outlet chamber along the direction from the first edge to the third edge, and
wherein a space is provided between the center partition wall and an inner wall surface of the third edge, and the first outlet and the second outlet communicate with each other via the space.

7. The fuel cell stack according to claim 6,
wherein a fuel inlet is provided at an edge side of the anode-side end plate, the edge side corresponding to the third edge side of the cathode-side end plate.

8. The fuel cell stack according to claim 6,
wherein the membrane electrode assembly is one of first and second membrane electrode assemblies, the fuel cell stack includes the first and second membrane electrode assemblies, and a separator interposed between the first and second membrane electrode assemblies,
the separator includes:
a first surface facing a cathode electrode of the first membrane electrode assembly, and
a second surface provided at a rear side of the first surface and facing an anode electrode of the second membrane electrode assembly,
the separator includes a first edge, a second edge that is adjacent to the first edge, a third edge that faces the first edge and is adjacent to the second edge, and a fourth edge that faces the second edge, the first to fourth edges are disposed at positions corresponding to the first edge, the second edge, the third edge, and the fourth edge of the cathode-side end plate, respectively, so that the separator is defined of a first edge side along the first edge, a second edge side along the second edge, a third edge side along the third edge, and a fourth edge side along the fourth edge,
the first surface of the separator includes:
an inlet provided at the first edge side,
an inlet chamber linked to the inlet,
a first outlet provided at the second edge side,
a second outlet provided at the fourth edge side,
an outlet chamber linked to the first outlet and the second outlet,
a plurality of linear partition walls provided in parallel to each other in a direction from the first edge to the third edge, and
a center partition wall provided in parallel to the plurality of linear partition walls in a center position, in the direction from the first edge to the third edge,
wherein the plurality of partition walls of the separator have a same length, and each two of the plurality of partition walls, and the center partition wall and two of the plurality of partition walls neighboring the center partition wall form a plurality of linear passages having a same width and being linked between the inlet chamber and the outlet chamber along the direction from the first edge to the third edge, and
wherein a space is provided between the center partition wall and an inner wall surface of the third edge in the separator, and the first outlet and the second outlet communicate with each other via the space.

9. The fuel cell stack according to claim 8,
wherein a fuel inlet is provided on edge sides of the anode-side end plate and the separator, each of the edge sides corresponding to the third edge side of the cathode-side end plate.

10. A fuel cell system comprising:
the fuel cell stack according to claim 6;
a fuel supply section configured to supply fuel to the fuel inlet and attached to a surface including the third edge of the cathode-side end plate of the fuel cell stack, and
a gas supply section configured to supply gas containing an oxidizing agent to the inlet of the cathode-side end plate,
wherein a fuel passage is provided on an anode-facing surface that faces the anode electrode of the anode-side end plate, and
a fuel inlet linked to the fuel passage is provided at an edge side of the anode-side end plate, the edge side corresponding to the third edge of the cathode-side end plate.

11. The fuel cell system according to claim 10,
wherein in the fuel cell stack, the membrane electrode assembly is one of first and second membrane electrode assemblies, the fuel cell stack includes the first and second membrane electrode assemblies, and a separator interposed between the first and second membrane electrode assemblies,
the separator includes:
a first surface facing a cathode electrode of the first membrane electrode assembly, and
a second surface provided at a rear side of the first surface and facing an anode electrode of the second membrane electrode assembly,
the separator includes a first edge, a second edge that is adjacent to the first edge, a third edge that faces the first edge and is adjacent to the second edge, and a fourth edge that faces the second edge, the first to fourth edges are disposed at positions corresponding to the first edge, the second edge, the third edge, and the fourth edge of the cathode-side end plate, respectively, so that the separator is defined of a first edge side along the first edge, a second edge side along the second edge, a third edge side along the third edge, and a fourth edge side along the fourth edge,
the first surface of the separator includes:
a gas inlet that is provided at the first edge side and that takes in gas containing an oxidizing agent from outside,
an inlet chamber linked to the gas inlet,
a first outlet provided at the second edge side,
a second outlet provided at the fourth edge side,
an outlet chamber linked to the gas outlet,
a plurality of linear partition walls provided in parallel to each other in a direction from the first edge to the third edge,
a center partition wall provided in parallel to the plurality of linear partition walls in a center position, in the direction from the first edge to the third edge,
wherein the plurality of partition walls of the separator have a same length, and each two of the plurality of partition walls, and the center partition wall and two of the plurality of partition walls neighboring the center partition wall form a plurality of linear passages having a same width and being linked between the inlet chamber and the outlet chamber along the direction from the first edge to the third edge,
a space is provided between the center partition wall and an inner wall surface of the third edge in the separator, and the first outlet and the second outlet communicate with each other via the space, and
the second surface is also provided with a fuel passage, the third edge side of the separator is provided with a fuel inlet linked to the fuel passage, and the fuel supply section supplies fuel to the fuel inlets provided in the anode-side end plate and the separator.
